(19) United States
(12) Patent Application Publication
(10) Pub. No.: US 2006/0180514 A1
(43) Pub. Date: Aug. 17, 2006

(54) Material catching, repositioning, and waste reducing apparatus with tilt capability

(76) Inventor: Thomas Leon Martin JR., Gap Mills, WV (US)

Correspondence Address: Thomas Leon Martin Jr., HC 83 Box 45-F, Union, WV, 24983, US

(21) Appl. No.: 11/256,363

(22) Filed: Oct. 21, 2005

Related U.S. Application Data
(60) Provisional application No. 60/621,356, filed on Oct. 23, 2004.

(51) Int. Cl. B07C 5/14

(52) U.S. Cl. 209/517

(57) ABSTRACT

A material catching, repositioning, and waste reducing machine comprising a main frame (57) that is joined to inner arms (15) that extend and contract in and out of outer arm tubes (22). A material skirt (52) is immovably attached to the outer arm tubes (22). The main frame (57) is mounted on a tilting bearing support (16). A tilt cylinder arm (51) that is immovably installed to the main frame (57), is operated by a tilt cylinder (38), and thus provides a means for tilting the machine.

### CROSS-REFERENCE TO RELATED APPLICATIONS

This application claims the benefit of provisional patent application Ser. No. 60/621,356 filed Oct. 23, 2004 by the present inventor.

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to the saw-mill machinery, specifically a material catching, repositioning, and waste reducing apparatus with tilt capability used for catching and repositioning wood cants and reducing the loss of wood products down slab chutes.

### BACKGROUND OF THE INVENTION—PRIOR ART

No other prior art is known.

### BACKGROUND OF INVENTION—OBJECTS AND ADVANTAGES

My material catching, repositioning, and waste reducing apparatus with tilt capability is a new invention that provides a much-needed apparatus that improves the quality and efficiency of the saw mill industry, and prevents the unnecessary loss of wood products. During the saw mill manufacturing process, after the last board cuts form a cant, this apparatus extends its inner arms to catch the cants to prevent them from dropping on the leftover boards. After a delay, the inner arms of the apparatus contract, allowing the cant to drop behind the boards to continue on. Because it repositions the cants and prevents them from dropping onto the boards, there is a significant reduction in damage to both cants and boards, thus improving their quality.. With the use of this invention, these boards no longer have to be handled manually, thus reducing the manual labor required and increasing the operation speed of the sawmill. Material loss to chippers will be significantly reduced because the apparatus has a material skirt that prevents the loss of valuable materials from going down the slab chute and ending up in a chipper as wasted product. The apparatus is also is designed to tilt with the slab dump, allowing the slab dump to dispose of slabs into the chute. No known prior art.

Several objects and advantages of the present invention are:
(a) To reduce the damages to cants and boards, thus improving their quality.
(b) To reduce the amount of manual labor required in the sawmill process.
(c) To increase the speed of the sawmill operation.
(d) To reduce the amount of valuable material being lost down the slab chute, thus increasing profitability.

### SUMMARY

The present invention is a machine comprising a main frame with arms that extend and contract pneumatically, a means for tilting the machine, and a material skirt for deflection of materials.

### DRAWINGS—FIGURES

FIG. 1—is a detailed top elevation view of the main frame of the material catching, repositioning, and waste reducing apparatus with tilt capability 56 with further details of main frame construction and the attachment of parts. In this illustration, the main frame end plates are permanently welded to each end of main frame, the tube bearings are attached to bearing supports, the axle shafts are inserted through collars into bearing, the rubber belts are secured to buffer mounts, and the tilt arm is attached to main frame.

FIG. 2—is a detailed top elevation view showing the mounting of a tilting arm to the right side of the main frame for the right side operation of the apparatus. Further installation is shown of the mounting of the material skirt, the mounting of the fins, the insertion of the wear pads and the wear pad cover plates, and the attachment of an air line hose support mount to the outer arm tubes. It is noted that a tilting arm could be mounted to the left side of the main frame to provide a left side operation of the apparatus.

FIG. 3—is a detailed top elevation view of the main frame showing the mounting of the outer arm tubes to the main frame. Also, there is further illustration of the mounting of the wear pads and the cover plates, with the use of bolts or other suitable fasteners, to the base side of the outer arm tubes.

FIG. 4—is a detailed base elevation view of the main frame of the apparatus with further illustration of the installation of the inner arms into the outer arm tubes on the main frame and the attachment of an arm connecting tube to the inner arms.

FIG. 6—is a detailed rear elevation view of the main frame of the apparatus with further illustration of the attachment of the horizontal yoke mount to the arm connecting tube, the mounting of the tilt cylinder to the tilt arm with further connection of the tilt arm to the tilt cylinder using the tilt cylinder yoke pin, the installation of the carter pins, and mounting of tilt cylinder mounts to the tilt cylinder.

FIG. 7—is a detailed right side elevation view of the main frame of the apparatus in horizontal position with further illustration of the connection of the horizontal cylinder to the mount connector using the horizontal cylinder collars and the further connection to the outer arm tubes, the connection of the horizontal yoke mount to the horizontal cylinders by the insertion of the horizontal cylinder yoke pins and the carter pins, with further illustration of tilt cylinder mount assembly which consists of the mounting of the tilt cylinder reinforcing plate onto the tilt cylinder mount, the attachment of the tilt cylinder collars to the tilt cylinder mount, and the tilt cylinder gussets with holes attaching to gusset connectors, therefore creating a removable tilt cylinder mount, further attachment of noise buffer to material skirt, the attachment of rubber belt to buffer using bolts or other suitable fastener. Further illustration shows the tilt direction and horizontal movement of apparatus during its operation.

FIG. 8—is a detailed right side elevation view of the apparatus in tilt position with the further illustration of the attachment of the arm stops to the inner arms, the connection of the gussets to the tilt cylinder mount, the attachment of the reinforcing plate to the mount, the attachment of the tilt cylinder collar to the mount, and the mount connection to the tilt cylinder.

FIG. 9—is a detailed top view of apparatus illustrating the horizontal movement of the arms and further illustration of the mounting of the tilt cylinder, which consists of removable tilt cylinder gusset with holes and tilt cylinder gussets, and the mounting of a stationary tilt cylinder.

FIG. 10—is a detailed top elevation view of the apparatus 56 illustrating the placement location of the horizontal cylinders. Further illustration shows the connection of the 1 piece mounts and the 2 piece removable mounts to the horizontal cylinders with further connection to the outer arm tubes, the attachment of air lines to the horizontal cylinders, and the mounting of hose mount to the outer arm tube.

FIG. 11—is an enhanced detail of the mounting of the horizontal tilt cylinders.

Illustrations of all parts used in the construction of this apparatus are provided. See parts illustrations 1 through 11.

### DRAWINGS—REFERENCE NUMERALS

11—main frame endplate
12—main frame tube
13—main tube connector
14—arm connecting tube
15—inner arm
16—bearing support
17—bearing
18—shafts axle
19—collar for end plates and tube connectors
20—¾ inch bolt 4 inches long
21—¾ inch nut locking type
22—outer arm tube
23—wear pads
24—wear pad coverplate
25—⅜ inch bolt ¾ inch long
26—⅜ inch bolt 1 inch long
27—⅜ inch nut
28—½ inch bolt 1½ inch long
29—½ inch nut
30—fins
31—arm stop
32—noise buffer
33—rubber belt
34L—left tilt cylinder mount
34R—right tilt cylinder mount
35—tilt cylinder collar
36—tilt cylinder reinforcement plate
37A—right horizontal cylinder
37B—left horizontal cylinder
38—tilt cylinder
39—horizontal cylinder yoke pin
40—cotter pin
41—tilt cylinder yoke pin
42—horizontal cylinder collar
43—horizontal cylinder 1 piece mount
44—spacer plate
45—horizontal cylinder 2 piece removable mount (base)
46—horizontal cylinder 2 piece mount (top)
47—mount connector
48L—left tilt cylinder gusset with hole
49R—right tilt cylinder gusset
50—gusset connector
51—tilt cylinder arm
52—material skirt
53—air line hose support mount
54—horizontal cylinder yoke mount
55—air line hose
56—material catching, repositioning, and waste reducing apparatus with tilt capability
57—main frame
58—main frame endplate attachment point
59—main tube connector attachment point
60—collar attach point
61—collar attach point
62—noise buffer attachment point
63—shaft axle entry point
64—shaft axle entry point
65—tilt cylinder attachment point
66—outer arm tube attachment point
67—material skirt attachment point
68—air line hose support attachment point
69—inner arm attachment point
70—inner arm assembly
71—yoke mount attachment point
72—cylinder collar attachment point
73—spacer plate attachment point
74—tilt cylinder reinforcement attachment point
75—tilt cylinder collar attachment point
76—gusset connector attachment point
77—noise buffer attachment point
78—right tilt cylinder gusset attachment point
79—arm stop attachment point
80—spacer plate attachment point
81—spacer plate attachment point
82—horizontal cylinder collar attachment point
83—spacer plate attachment point
84—hose support mount attachment point
85—fins attachment point

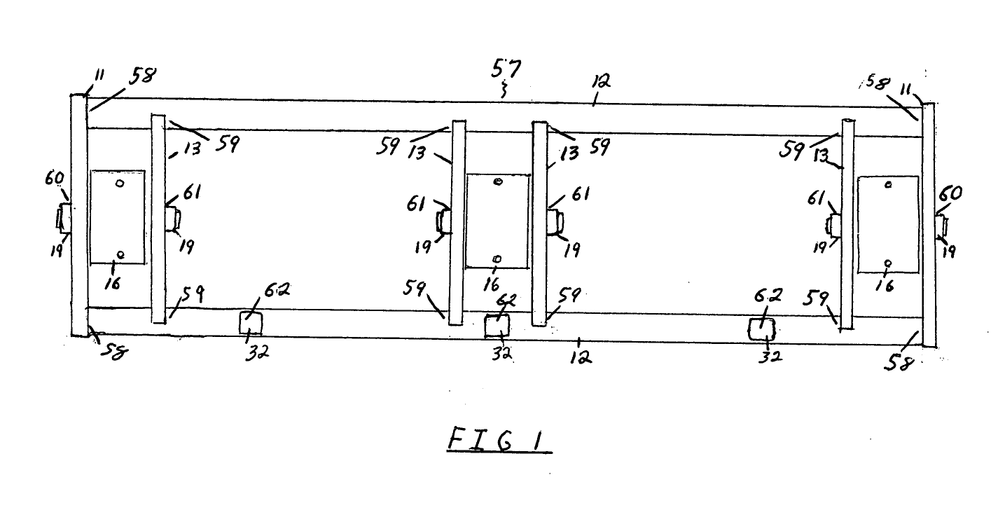

### DETAILED DESCRIPTION—FIGS. 1 TO 10—PREFERRED EMBODIMENT

A detailed top elevation view of the construction of the main frame 57 of the cant catching, repositioning, and waste reducing apparatus with tilt capability 56 with further details of the attachment of other parts is shown in FIG. 1. The main frame end plates 11 are immovably installed (e.g. welded, etc.) to each end of main frame tubes 12 at main frame endplate attachment points 58. The main tube connectors 13 are immovably installed (e.g. welded, etc.) to inside wall of main frame tubes 12 at main tube connector attachment points 59. The collars for end plates and tube connectors 19 are immovably installed (e.g. welded, etc.) to main frame end plates 11 at collar attachment points 60. Further collars for end plates and tube connector 19 are immovably installed (e.g. welded, etc.) onto main tube connectors 13 at collar attachment points 61. The noise buffers 32 are immovably installed (e.g. welded etc.) to the main frame tube 12 at noise buffer attachment points 62. The bearing supports 16 are positioned between main frame endplates 11 and main tube connectors 13. Another bearing support 16 is further positioned between the main tube connector 13 and main tube connector 13. A further bearing support 16 is positioned between the main tube connector 13 and the main frame endplate 11 (see FIG. 1).

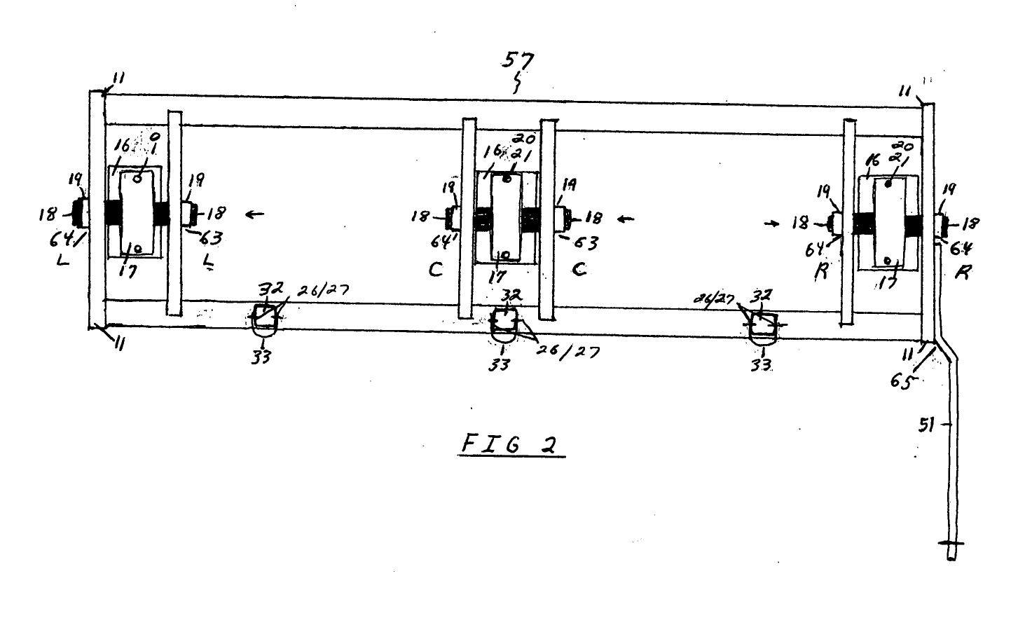

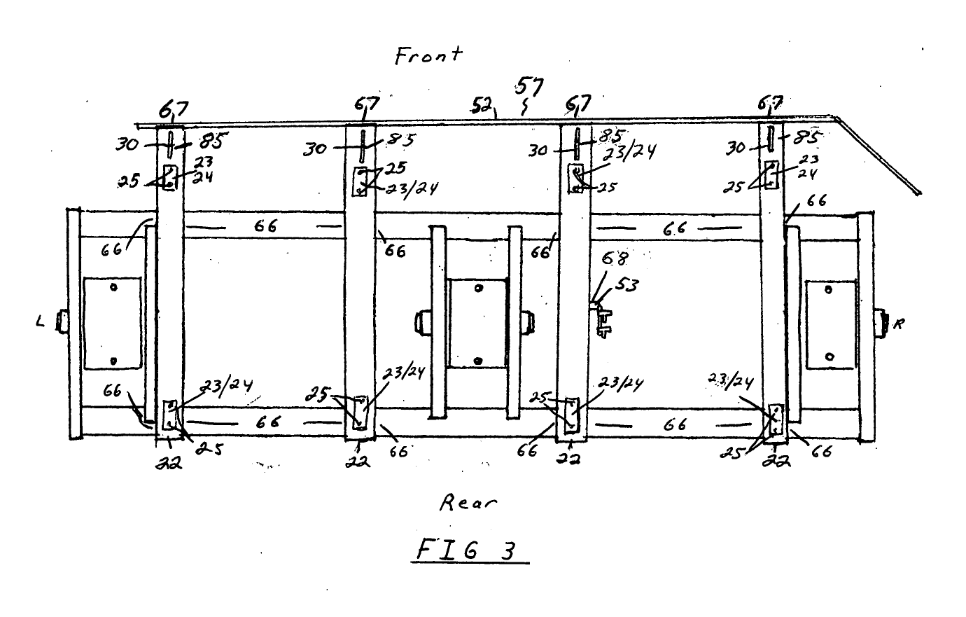

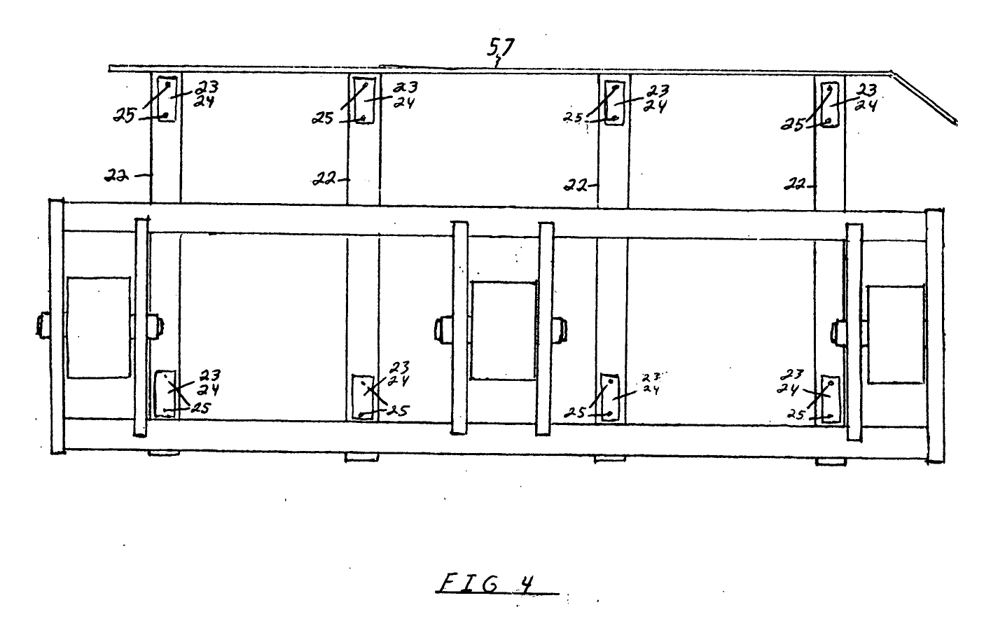

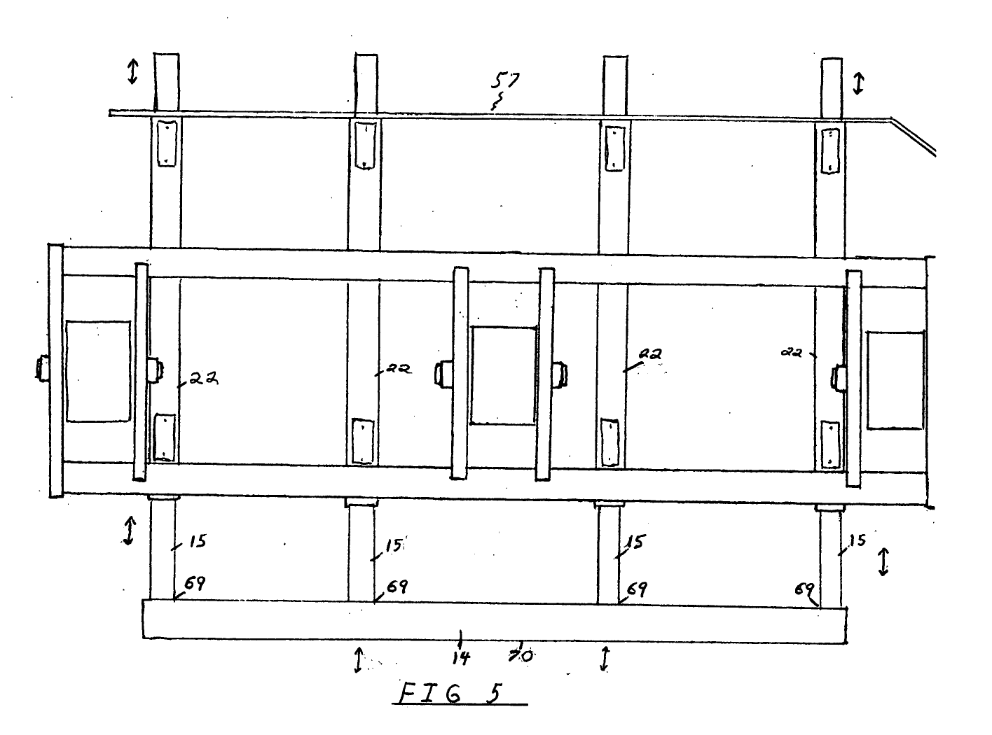

A detailed top elevation view illustrating the mounting of the tilting arm to the main frame 57 for right side operation is shown in FIG. 2. The further installation of other parts is shown. The bearing 17 is secured to bearing support 16 with a bolt 20 and a nut 21, or other suitable fasteners. The shaft axle 18 is installed through the center of the collar for end plates and tube connectors 19 at the shaft axle entry point 63, then is passed through the center of the bearing 17, and then is passed through the collar 19 at shaft axle entry point 64. This process is repeated again on the left side, center, and right side of main frame 57. This assembly is the start of the pivot action and tilt capability of the apparatus 56. The rubber belts 33 are removably secured to the noise buffer 32 with a bolt 26 and a nut 27, or other suitable fasteners. The tilt cylinder arm 51 is immovably installed (e.g. welded, etc.) onto the main frame endplate 11 on right side at tilt cylinder attachment point 65. The tilt cylinder arm 51 can be immovably installed (e.g. welded, etc.) to main frame endplate 11 on the left side to create left side operation.

A detailed top elevation view of main frame 57 illustrating the mounting of outer arm tubes to the main frame, with further installation of the attachment of other parts is shown in FIG. 3. The outer arm tubes 22 are immovably installed (e.g. welded, etc.) onto the top of the main frame tubes 12 at the outer arm tube attachment points 66. The material skirt 52 is immovably installed (e.g. welded, etc.) onto the front ends of the outer arm tubes 22 at a plurality of material skirt attachment points 67. The wear pads 23 are installed into the openings on top of the outer arm tubes 22. The wear pad cover plates 24 are removably secured onto the top side of the outer arm tubes 22, and over top of the wear pads 23 using a bolt 25. The air line hose support mount 53 is immovably installed (e.g. welded, etc.) onto the top side front end of the outer arm tube 22, respectively at the air line hose support attachment point 68. The fins 30 are immovably installed (e.g. welded, etc.) to the top side of the outer arm tube 22 at the fins attachment point 85.

A detailed base elevation view of the main frame 57 with further illustration of the installation of parts is shown in FIG. 4. The wear pads 23 are installed into the openings on the base side of the outer arm tubes 22 (see FIG. 4). The wear pad cover plates 24 are installed onto the base side of the outer arm tubes 22, and over the top of the wear pads 23, and removably secured with bolts 25.

A detailed base elevation view of the main frame 57 with further illustration of the extending and contracting operation of the inner arms 15 is shown in FIG. 5. In the FIG. 5, the extending and contracting operation of the inner arms 15 is shown in arrowed solid lines illustrating direction. Installation of more parts is also shown. The inner arms 15 are immovably installed to the arm connecting tube 14 at the inner arm attachment points 69. This inner arm assembly 70 is further installed into and through the outer arm tube 22.

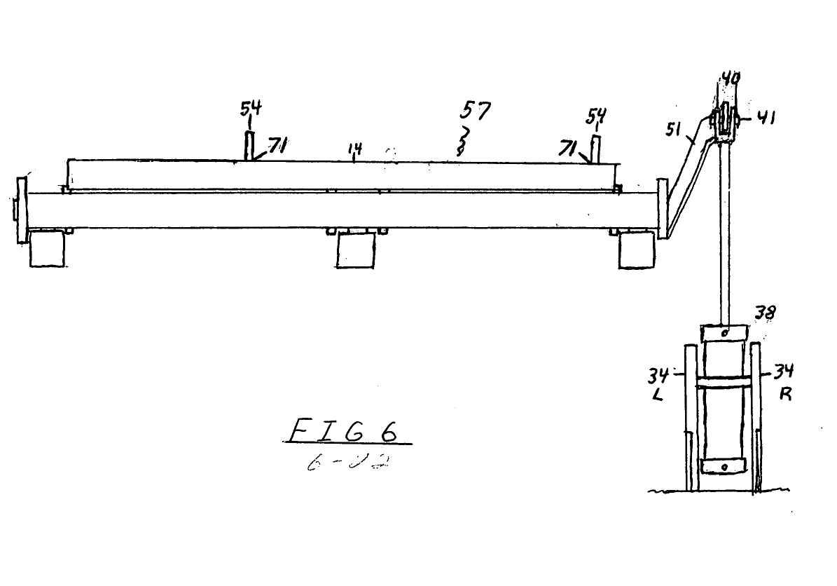

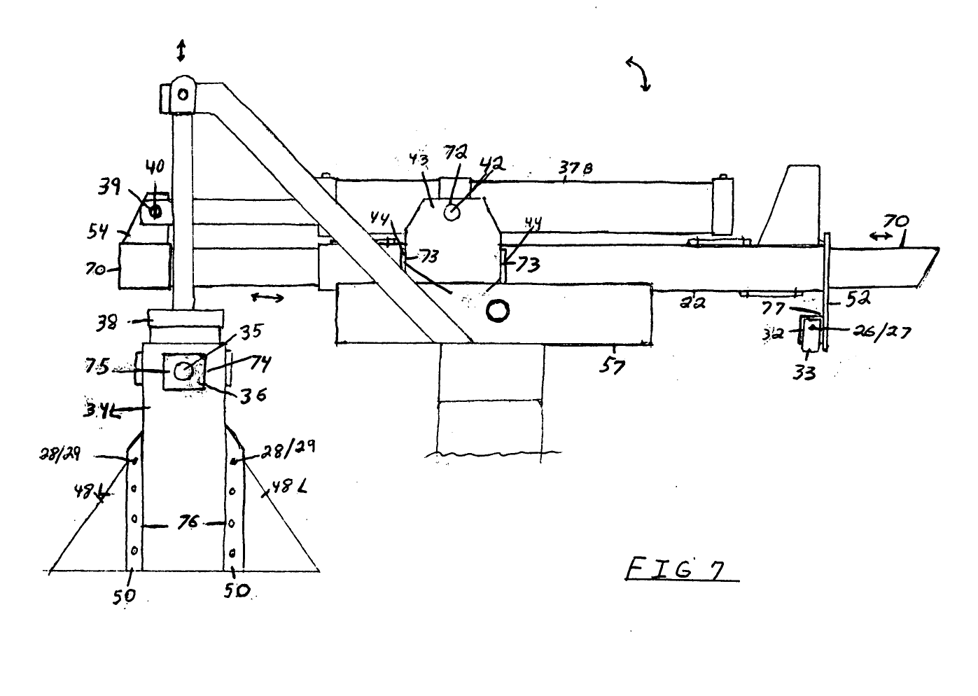

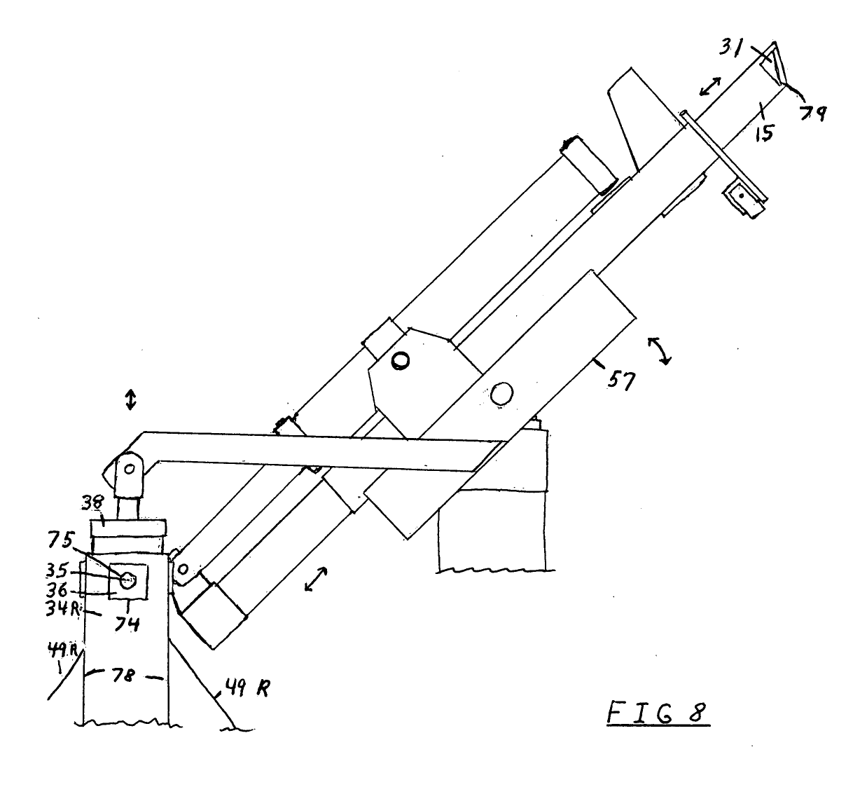

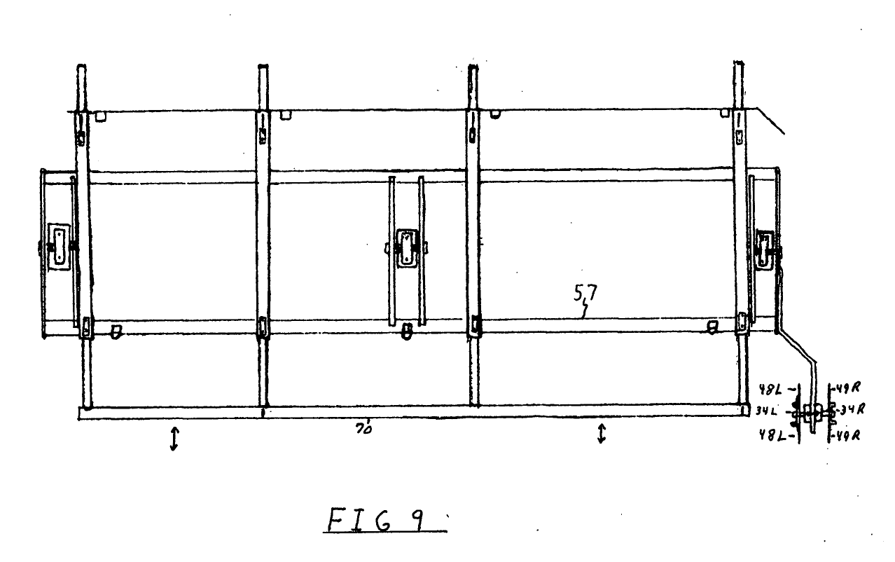

A detailed rear elevation view of the main frame 57 illustrating the tilt connection is shown in FIG. 6. The further installation of parts is also shown. The horizontal cylinder yoke mounts 54 are immovably installed (e.g. welded, etc.) onto the arm connecting tube 14 at the yoke mount attachment points 71. The tilt cylinder 38 is installed onto the tilt cylinder arm 51 with a tilt cylinder yoke pin 41, or other suitable fastener, and the tilt cylinder yoke pin 41 is secured with cotter pins 40, or other suitable fasteners, on each end. The left tilt cylinder mount 34L is installed onto the left side of tilt cylinder 38 and the right tilt cylinder mount 34R is installed onto to the right side of tilt cylinder 38 (Details are further illustrated in FIG. 7.)

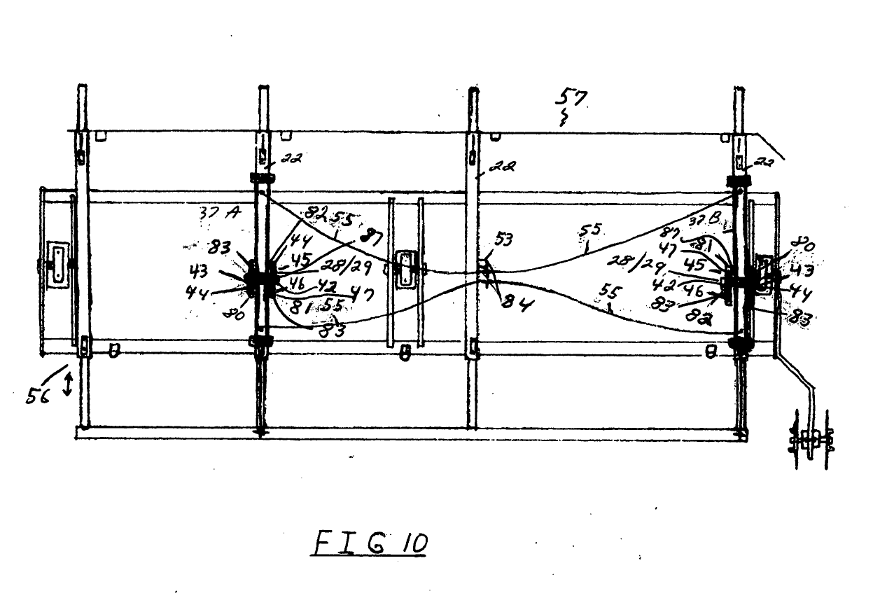

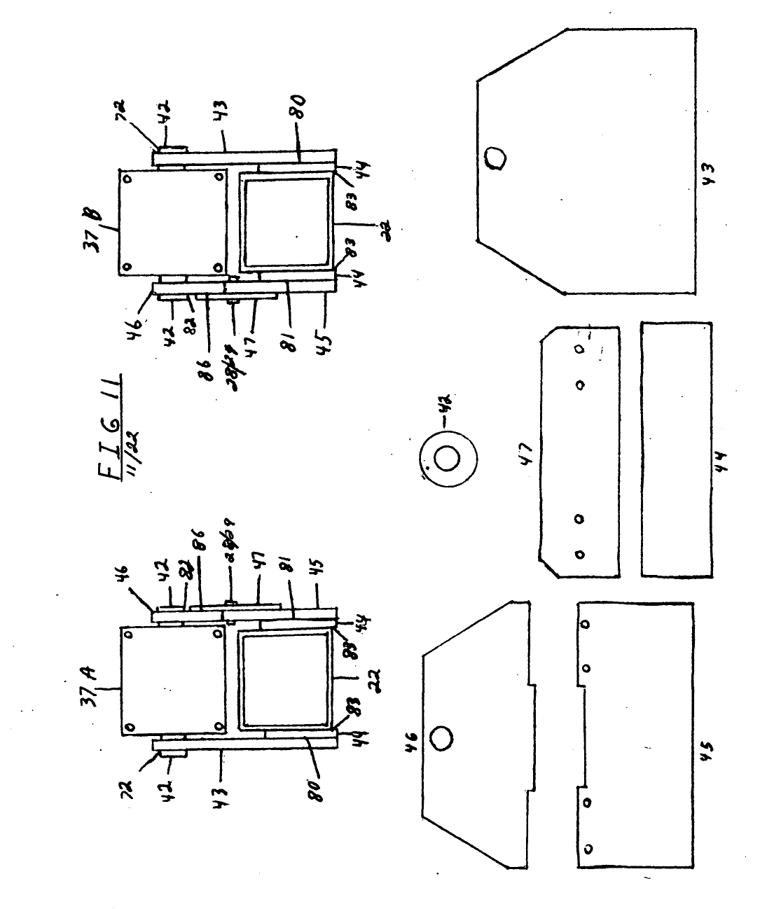

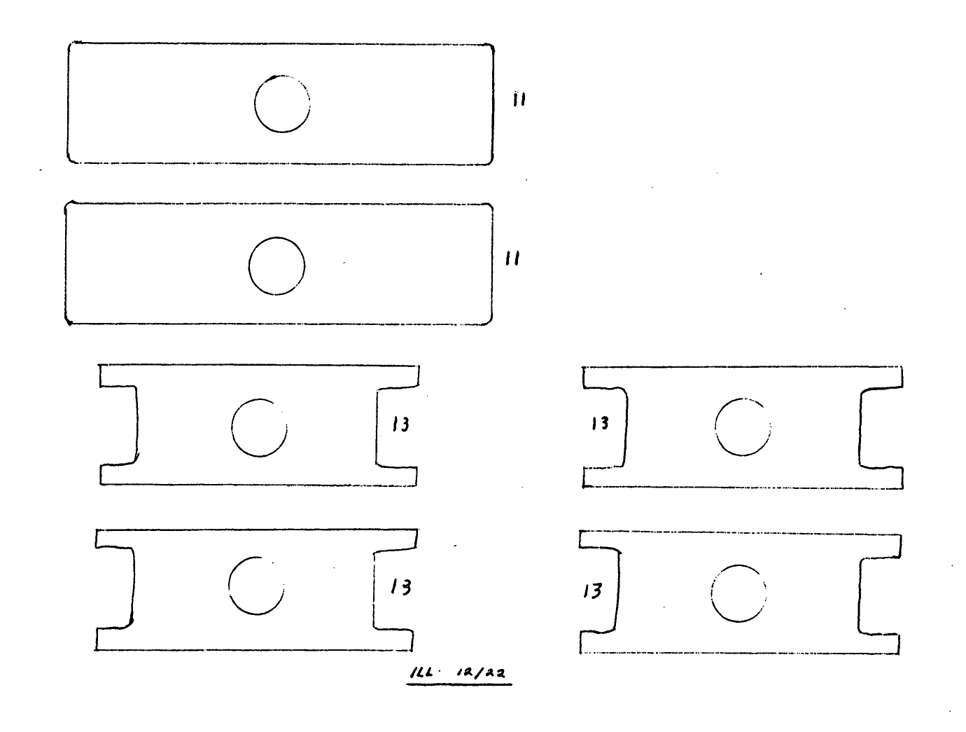

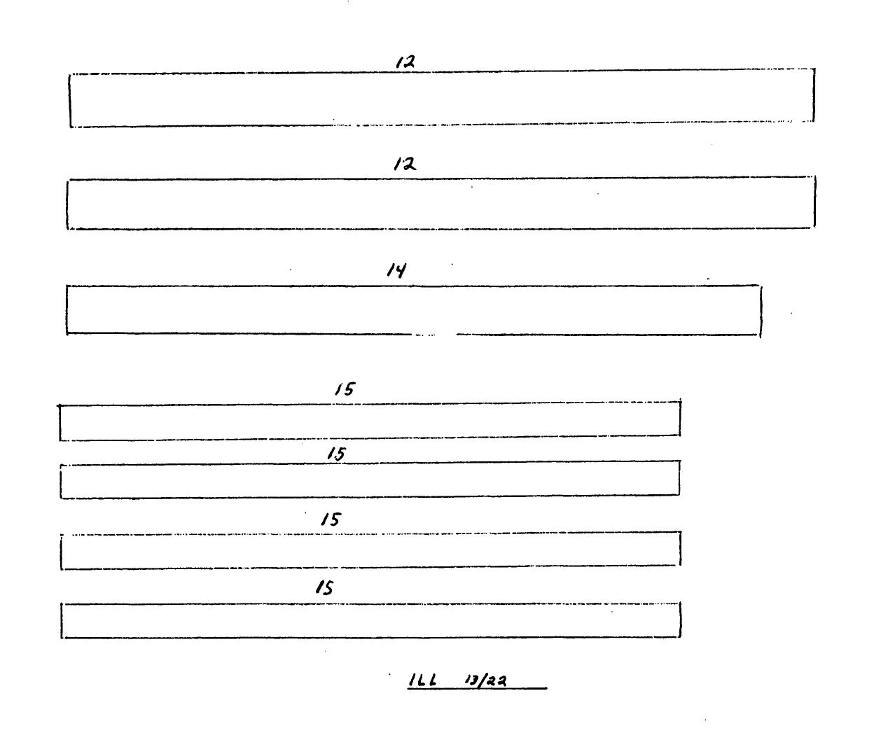

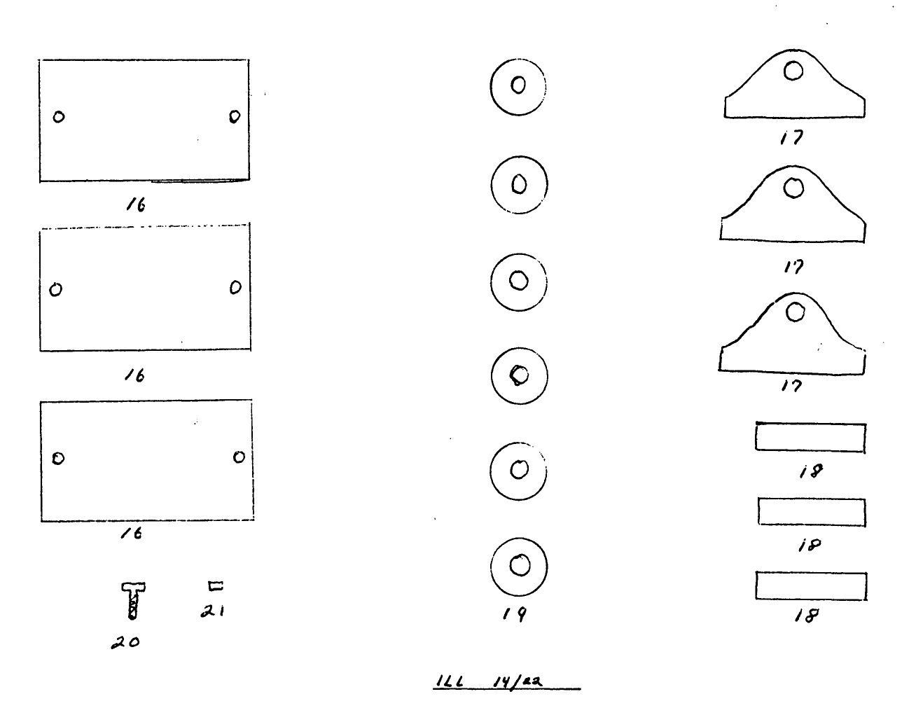

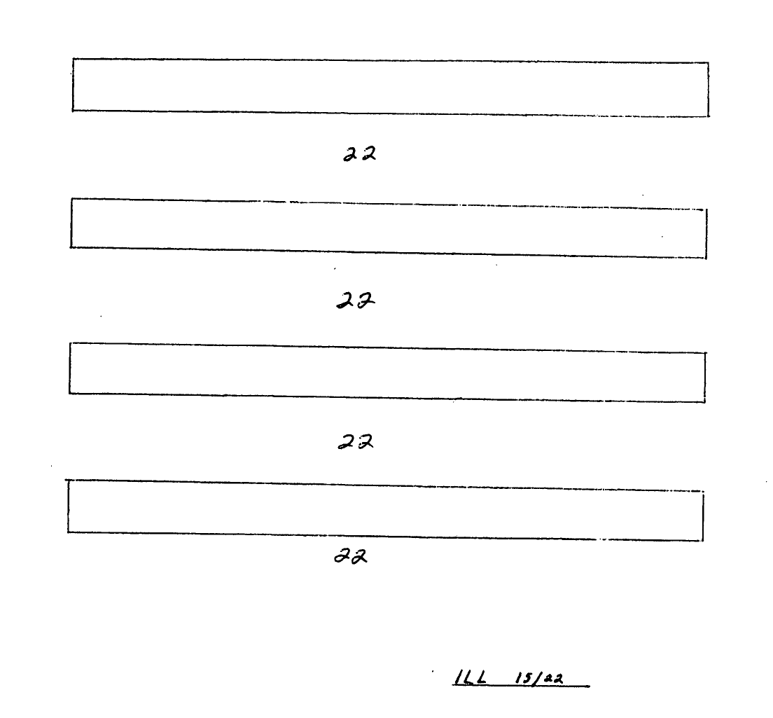

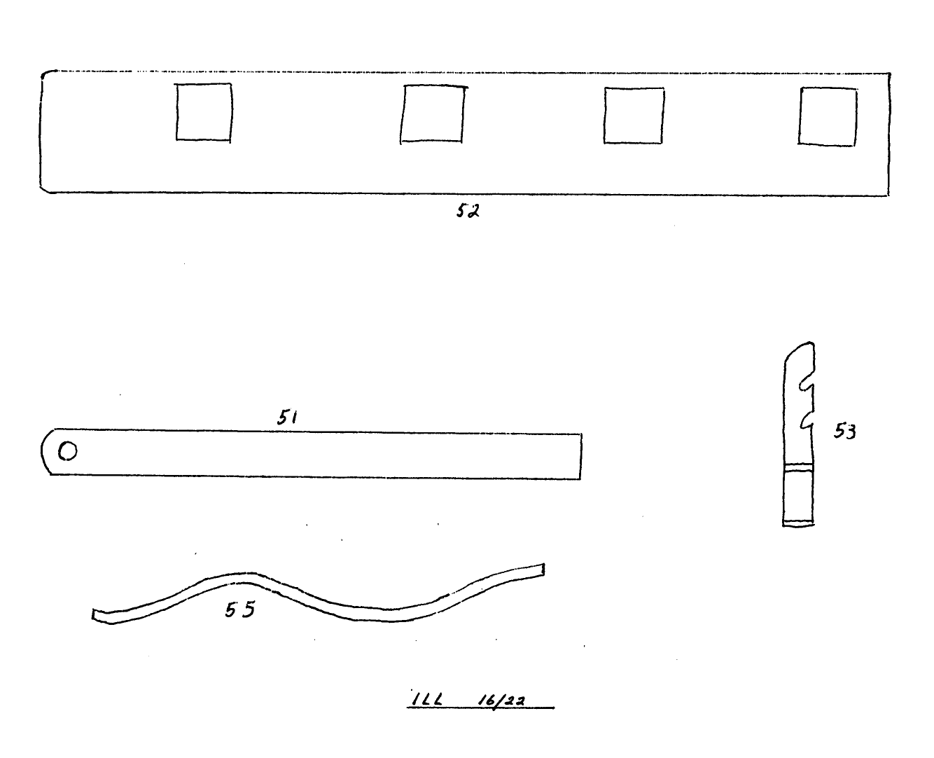

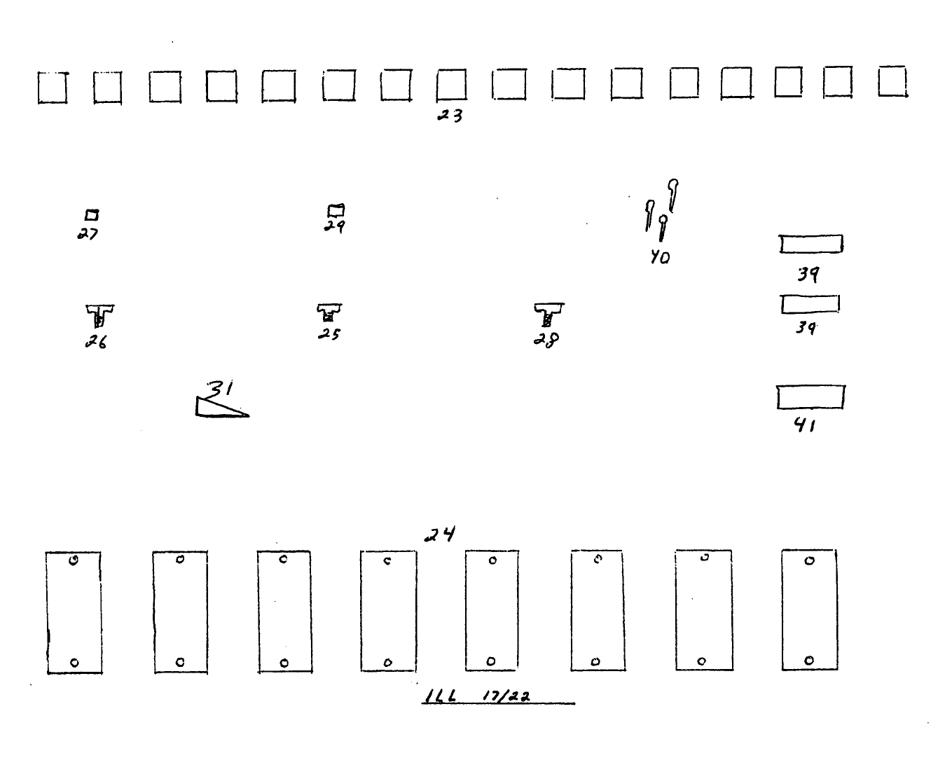

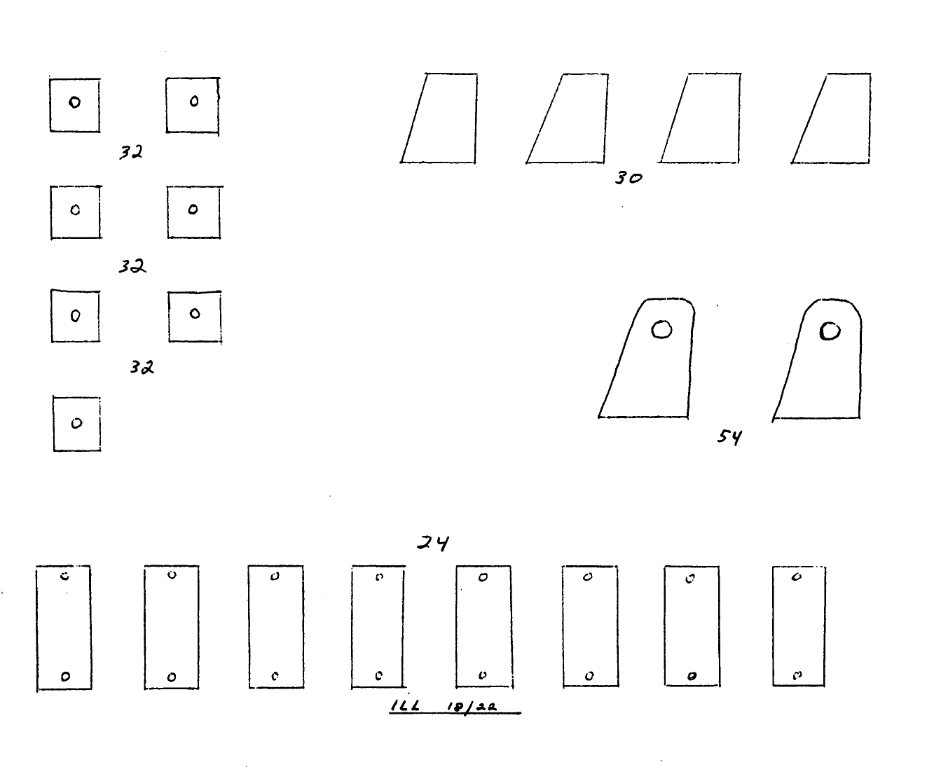

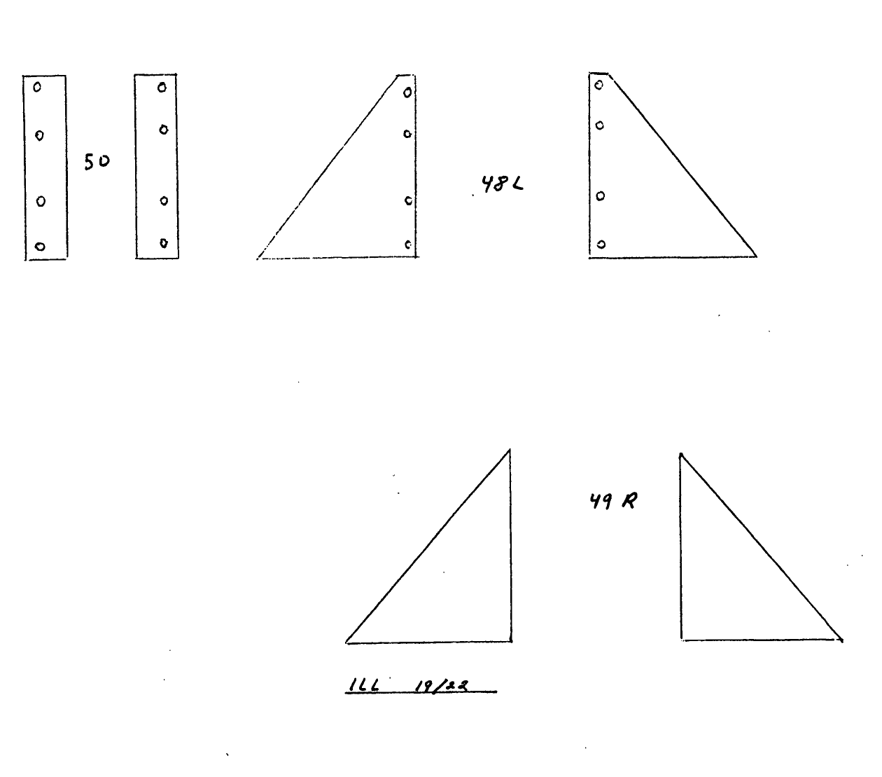

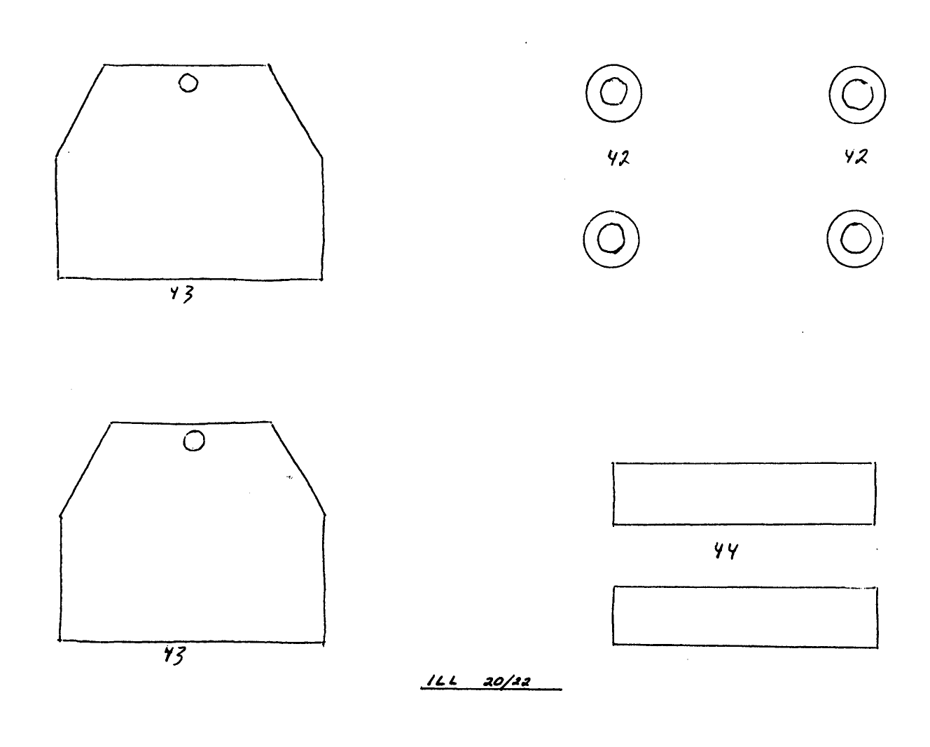

FIG. 7 is a detailed right side elevation view of the main frame 57 illustrating the tilt capability and the horizontal movement of the inner arms assembly 70 during the operation of the apparatus 56. The horizontal cylinder collars 42 are immovably installed (e.g. welded) to the horizontal cylinder 1 piece mounts 43 at the cylinder collar attachment points 72. The spacer plates 44 are immovably installed (e.g. welded, etc.) to the outer arm tubes 22 at the spacer plate attachment points 73. (See FIG. 10 for the enhanced detail of these part connections). The horizontal cylinder 1 piece mounts 43 are immovably installed (e.g. welded, etc.) onto the spacer plates 44 at the horizontal cylinder 1 piece mount attachment points 80. The horizontal cylinder 37B is slid through the opening in the horizontal cylinder collar 42. The tilt cylinder reinforcement plate 36 is immovably installed (e.g. welded) onto the tilt cylinder mount 34L at the plate attachment point 74. The tilt cylinder collar 35 is immovably installed (e.g. welded, etc.) onto the tilt cylinder reinforcement plate 36 at the tilt cylinder collar attachment point 75. The gusset connectors 50 are immovably installed (e.g. welded, etc.) onto each side of the tilt cylinder mount 34L at the gusset connector attachment points 76. The tilt cylinder gussets with holes 48L are removably installed to the gusset connectors 50 with bolts 28 and nuts 29, or other suitable fasteners. This assembly creates the 2 piece removable tilt cylinder mount. The tilt cylinder mount 34L is slid through opening in the tilt cylinder collar 35 and onto the tilt cylinder 38. The horizontal cylinder 37B is removably secured to the horizontal cylinder yoke mount 54 with a horizontal cylinder yoke pin 39 and the horizontal cylinder yoke pin is further secured with cotter pins 40. The tilt cylinder mount 37A is removably secured onto the horizontal cylinder yoke mount 54 with a horizontal cylinder yoke pin 39 and this pin is further secured with cotter pins 40. The rubber belt 33 is removably installed onto the noise buffer 32 using a bolt 26 and a nut 27, or other suitable fasteners. The noise buffers 32 are immovably installed (e.g. weld, etc.) onto the material skirt 52 at the noise buffer attachment points 77.

FIG. 8 is a detailed right side elevation view of the apparatus 56 in tilt position with further illustration of the attachment of parts. The tilt cylinder reinforcement plate 36 is immovably installed (e.g. weld, etc.) onto the tilt cylinder mount 34R at the tilt cylinder reinforcement plate attachment point 74. The tilt cylinder collar 35 is immovably installed (e.g. weld, etc) onto the tilt cylinder reinforcement plate 36 at the tilt cylinder attachment point 75. The right tilt cylinder gusset 49R is immovably installed (e.g. weld, etc.) onto the tilt cylinder mount 34R at the right tilt cylinder gusset attachment point 78. The arm stop 31 is immovably installed (e.g. weld, etc.) onto the inner arm 15 at the arm stop attachment point 79.

FIG. 9 is a detailed top view of the main frame 57 of the apparatus 56 showing the horizontal movement of the arms of the apparatus 56, with further illustration of their assembly. The locations of the connections of the left tilt cylinder gusset with hole 48L and the right tilt cylinder gusset 49R in relation to the left tilt cylinder mount 34L and right tilt cylinder mount 34R are illustrated.

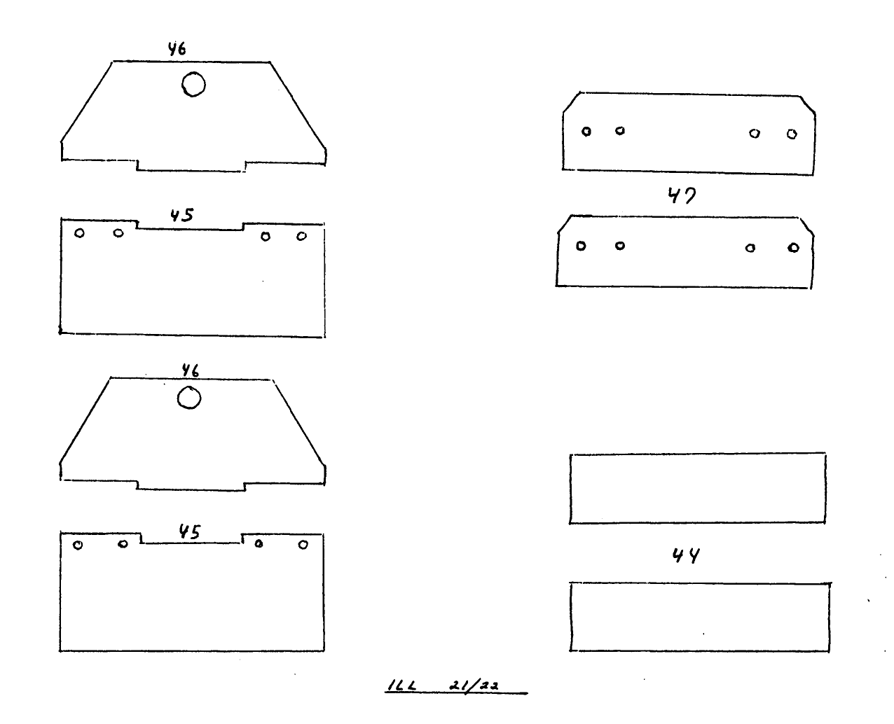

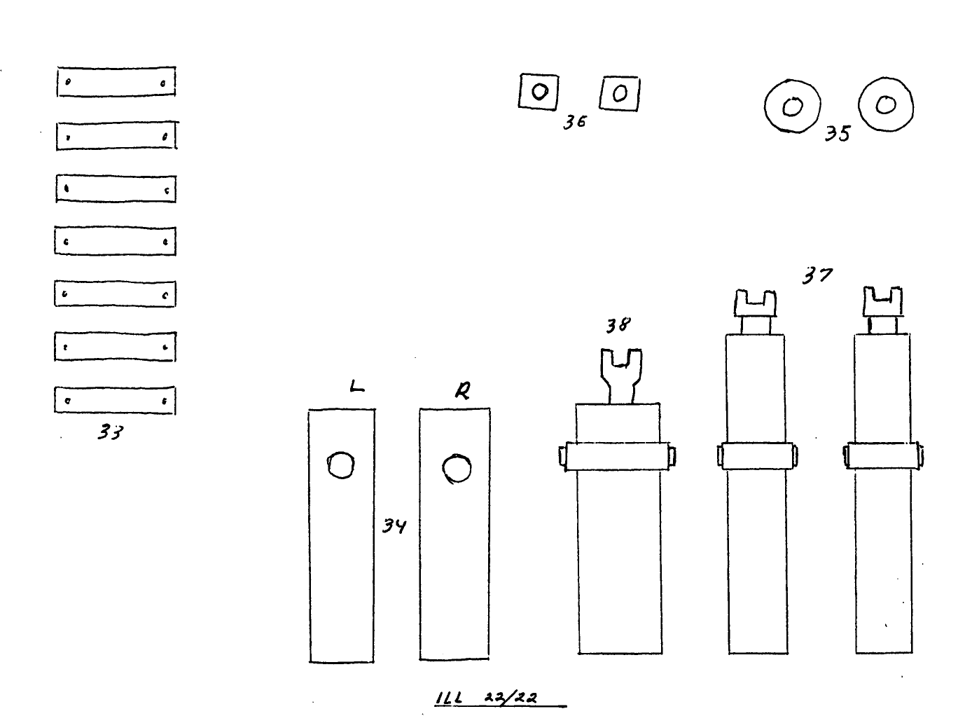

FIG. 10 is a detailed top elevation view of the main frame 57 of apparatus 56 with further illustration showing the placement location of the right horizontal cylinder 37A and left horizontal cylinder 37B. Further illustration shows the connection of the horizontal cylinder 1 piece mount 43, the horizontal cylinder 2 piece removable mount (base) 45, the horizontal cylinder 2 piece mount (top) 46, and mount connector 47 to the horizontal cylinders (See FIG. 11 for enhanced detail of these horizontal cylinder mounts). The spacer plate 44 is immovably installed (e.g. weld, etc.) onto the horizontal cylinder 1 piece mount 43 at the spacer plate attachment point 80 (See FIG. 11 for enhanced detail). The spacer plate 44 is immovably installed (e.g. weld, etc.) onto the horizontal cylinder 2 piece removable mount (base) 45 at the spacer plate attachment point 81. (See FIG. 11). The horizontal cylinder 2 piece mount (top) 46 is removably installed onto the horizontal cylinder 2 piece removable mount (base) 45 with a bolt 28 and a nut 29, or other suitable fasteners (See FIG. 11). The horizontal cylinder 2 piece mount (top) 46 is immovably installed (e.g. welded, etc.) onto the mount connector 47 at horizontal cylinder 2 piece mount attachment point 86 (See FIG. 11). The horizontal cylinder 2 piece removable mount (base) 45 is removably installed onto mount connector 47 with bolt 28 and nut 29, or other suitable fasteners (See FIG. 11). The horizontal cylinder collar 42 is immovably installed (e.g. weld, etc.) onto the horizontal cylinder 2 piece mount (top) 46 at horizontal cylinder collar attachment point 82 (See FIG. 11). The spacer plate 44 is immovably installed (e.g. weld, etc.) onto the outer arm tube 22 at the spacer plate attachment point 83. The air line hose support mount 53 is immovably installed (e.g. weld, etc.) onto the outer arm tube 22 at the hose support mount attachment point 84. The air line hoses 55 are attached onto the right horizontal cylinder 37A and left horizontal cylinder 37B, and further connected to the air line hose support mount 53. The horizontal cylinder collars 42 are connected to the pins by sliding them over the right horizontal cylinder 37A and also onto the left horizontal cylinder 37B.

### OPERATION—FIGS. 3, 7, 8, 9

The extending and contracting horizontal operation of the material catching, repositioning, and waste reducing apparatus with tilt capability 56 (shown in FIG. 9) is powered by air cylinders, respectively the right horizontal cylinder 37A, left horizontal cylinder 37B, and tilt cylinder 38. The right horizontal cylinder 37A and left horizontal cylinder 37B connect to the parts of the apparatus, respectively at the main frame 57 and inner arm assembly 70. Horizontal travel is obtained when air is deposited into either end of the right horizontal cylinder 37A and left horizontal cylinder 37B simultaneously, and controlled by electric air solenoids, to allow for the extending or the contracting the inner arm assembly 70. This inner arm assembly 70 operation is only one of the operations of machine 57. During a facility's operation, the arms can extend out to catch materials and hold them on a delay. This allows for the separation of one material from another when needed. The arms then contract and release the material to travel on its way in the facility. The extending and contracting of the operation of the right horizontal cylinder 37A and left horizontal cylinder 37B is controlled by a 100 psi continuous air supply from a facility's system. The facilities system connects to the apparatus at the base of left tilt cylinder mount 34L and right tilt cylinder mount 34R.

A second operation of the apparatus is the tilting capability (shown in FIGS. 7 and 8) powered by the tilt cylinder 38 in a vertical position. The left tilt cylinder mount 34L and right tilt cylinder mount 34R are connected to facility's air supply system at their bases. The tilt cylinder 38 is then attached to the main frame 57 by connecting to the tilt cylinder arm 51. The air supply from a facility is controlled by an electric air solenoid that supplies 100 psi continuously when needed to operate the tilt cylinder 38. This enables the tilt cylinder to extend and contract vertically, providing the tilting operation of the apparatus 56. The main frame 57 pivots on the bearing 17 and the bearing support 16. The tilt operation capability of the apparatus 57 operates fluidly with the facility's operation, by tilting up and out of the way to allow for the dumping of the facility's materials. When the apparatus 57 is in horizontal position, a material skirt 52 (shown in FIG. 3) on the front area of the apparatus prevents the loss of material from passing underneath the apparatus. The tilt operation capability of the apparatus 57 flows with the facility's operation, so that when the dumping of materials is needed in the facility, the main frame 57 is tilted by the tilt cylinder 38, allowing the apparatus to lift upward so material can pass underneath the material skirt 52. The apparatus 56 rests and tilts on the bearing support 16, which is attached to the facility's main structure for the support of the apparatus 56, and can span over slab dump areas. The apparatus can also be designed and set up over many different spanning areas or holes in any facility.

### ALTERNATIVE EMBODIMENTS

The inner arm assembly 70 can have a plurality of spacing of the arms to accommodate a plurality of material lengths.

The apparatus has been described throughout to be used in the operation of the sawmill industry. Alternatively, this design can be used in many industrial operations where catching and sorting of materials takes place.

The machine has been described throughout as operating fluidly with a facility's operations. Alternatively, it can operate independently of the other operations of a facility.

The design of the apparatus is not limited to the operation over slab dumps in a saw mill. Alternatively, the apparatus can be designed and set up over many different spanning areas or holes in any facility.

The apparatus 56 is illustrated throughout the drawings as a right hand operating apparatus. Alternatively, the design of the apparatus can be constructed to be used in left hand operation in a facility.

This machine may be constructed using the metal materials described above. Alternatively, other construction materials (e.g. steel, aluminum, fiber materials, etc.) may be used for large scale production, if so desired.

The tilting axis pivot design, arm spacing, and 2 piece removable cylinder mounts of the apparatus are unique in themselves in the illustration. Alternatively, they can have a plurality of designs or sizes.

Different air cylinders can be used in the construction of this apparatus.

Different materials, sizes, shapes, and interconnections can be used for all components of this apparatus.

Advantages

From the description above, a number of advantages of my apparatus become evident:
(a) The ability of the arms to extend and catch the cants while the waste product drops and passes by prevents the waste product from dropping on the cants and causing damage, thus resulting in a higher quality of board cants.
(b) The tilting capability allows for the machine to tilt up and away from the slab dump, thus enabling the machine to allow for the separation of good and bad materials.
(c) The material skirt along the front of the machine helps to align materials into proper positions and prevents the loss of good products down the slab chutes.
(d) Profitability increases for the sawmill industry due to the prevention of good products accidentally falling into the slab chute.
(e) The ability of the machine to be used in left or right hand operation allows the machine to be installed without having to rearrange the operation.
(f) The plurality of sizes of the machines main parts enables the machine to be custom-fitted to each individual sawmill.

### CONCLUSION, RAMIFICATIONS, AND SCOPE

Accordingly, the reader will see that this machine has the capability to catch materials with the attached arms, has the capability to tilt with the slab dump, a material skirt to deflect and align good materials away from the slab dump, and to prevent damage to the good materials during the operation of the sawmill.

Although the description above contains many specifications, these should not be construed as limiting the scope of the invention but as merely providing illustrations of some of the presently preferred embodiments of this invention. For example, the arms can have a plurality of lengths, spacing, and use of a variety of materials; the axils attached to the main frame supported by the designed feet can be spaced at a plurality of positions and tilt at a plurality of degrees; the material skirt can be designed and built using a plurality of lengths and heights: the machine can be designed without the tilt capability, etc.

I claim:

1. A machine for catching, repositioning, and sorting materials comprising:
(a) a main frame,
(b) a plurality of elongated support members of substantially equal lengths,
(c) a means for joining said elongated support members to the said main frame at spaced locations so as to be able to support said elongated support members horizontally,
(d) a second means for extending and contracting the elongated support members,
(e) a third means for tilting said machine,
(f) a fourth means for deflecting said materials away from said machine,
Whereby the said machine is able to catch, reposition, and sort materials and provide a means for said machine to tilt.

2. The machine in claim 1 wherein said main frame is made of a metal.

3. The machine in claim 1 wherein said elongated support members are made of metal tubes.

4. The machine in claim 1 wherein said means for joining comprises cylinders mounted horizontally on mounts attached to said main frame.

5. The machine in claim 1 wherein said means for extending and contracting comprises an inner arm assembly that extends and contracts through outer arm tubes.

6. The machine in claim 1 wherein said means for tilting comprises of a 2 piece removable tilt cylinder mount attached to the main frame.

7. The machine in claim 1 wherein said means for deflecting comprises a material skirt that is made of metal and attached to the front ends of the said outer arm tubes at a plurality of attachment points.
